(19) United States
(12) Patent Application Publication
(10) Pub. No.: US 2022/0079346 A1
(43) Pub. Date: Mar. 17, 2022

(54) LIGHT-EMITTING SEAT

(71) Applicant: DAKANG HOLDING CO., LTD., Zhejiang (CN)

(72) Inventors: Rujia Mao, Huzhou, Zhejiang (CN); Xiaoyu He, Huzhou, Zhejiang (CN); Guofei Yuan, Huzhou, Zhejiang (CN); Haitao OUYANG, Huzhou, Zhejiang (CN)

(73) Assignee: DAKANG HOLDING CO., LTD., Zhejiang (CN)

(21) Appl. No.: 17/422,205

(22) PCT Filed: Jan. 2, 2020
(86) PCT No.: PCT/CN2020/070071

§ 371 Date: Jul. 12, 2021

(30) Foreign Application Priority Data
Nov. 28, 2019 (CN) 201922098945.2

(51) Int. Cl. A47C 7/72; F21V 33/00

(52) U.S. Cl. CPC A47C 7/725; F21W 2131/301; F21V 33/0012

(57) ABSTRACT

A light-emitting seat includes a seat body, a strip light module, and a skin layer. The seat body includes a chair frame and a soft filling layer. The strip light module includes a strip light and a light guide material layer. The light guide material layer covers the strip light. The strip light module is disposed on the chair frame. The skin layer covers the seat body and the strip light module, and an area of the skin layer at least covering the strip light module is a light-transmitting material. The strip light is covered through the light guide material layer, light is refracted in the light guide material layer.

### BACKGROUND

### Technical Field

The disclosure relates to a seat, and more particularly to a light-emitting seat for creating an atmosphere.

### Description of Related Art

With the vigorous development of the e-sports industry, various peripheral products related to e-sports emerge in endlessly. Professional e-sports players and most game players have special requirements for the atmosphere and visual effects of the entire game in order to pursue the game experience. As such, e-sports chairs came into being.

In addition to the pursuit of ultimate performance, the various e-sports related products launched on the market have a certain pursuit for cool effects of the appearance. The patent application with Application No. CN108652308A discloses a seat with side strip lights, including a seat body and a side strip light module. The side strip lights are disposed along an outer ledge curve of a cushion part or an outer ledge curve of a chair body part of the seat body. The visual effects of the e-sports seat are enhanced through light emission of the side strip light module, thereby satisfying the pursuit of the user for cool and dazzling effects. However, direct light emission through the side strip light causes the light to be not soft, the visual comfort is low after long-term contact, the visual effects are poor, and the overall e-sports chair does not have a high-end appearance.

### SUMMARY

In view of the above defects and issues of the prior art, the disclosure provides a light-emitting seat, which includes the following.

A seat body includes a chair frame and a soft filling layer. The soft filling layer is disposed outside the chair frame and avoids a region where a light guide material layer is located.

A strip light module includes a strip light and the light guide material layer. The light guide material layer covers the strip light. The strip light module is disposed on the chair frame. Light is refracted through the light guide material layer to form soft light.

A skin layer covers the seat body and the strip light module, and at least an area of the skin layer covering the strip light module is a light-transmitting material. The light-transmitting material is transparent or translucent, so that light emitted by the strip light module may be displayed on a seat surface.

A power supply assembly is electrically connected to the strip light to supply electrical energy.

Preferably, the soft filling layer and the light guide material layer are integrally formed. A material for integral formation may be a material that has both functions of light guiding and soft cladding or may be a splicing of two materials that respectively have the functions of light guiding and soft cladding.

Preferably, the chair frame is provided with a groove for accommodating the strip light. The strip light is fixed in the groove. The light guide material layer covers the groove, such that a certain distance is defined between the strip light and the light guide material layer, and that soft light effects are better.

Preferably, the chair frame includes a seat frame and a backrest frame. The strip light may be disposed on the seat frame and the backrest frame at the same time or may be disposed on one of the seat frame and the backrest frame.

Preferably, the strip light is disposed on an edge of the backrest frame and/or an edge of the seat frame.

Preferably, the strip light is disposed in a middle region of the backrest frame and/or a middle region of the seat frame.

Preferably, the strip light is selected from one or more of an RGB light strip and an LED light strip.

Preferably, the light guide material layer is selected from one or more of foam, EVA, and EPE.

Preferably, the light-transmitting material is selected from one or more of mesh cloth, silica gel, and transparent plastic.

Preferably, the light-emitting seat further includes a control panel, which can receive a signal to control a color and a sequence of light emitted by the strip light.

Preferably, the strip light may emit at least two colors of light, so that the overall light-emitting seat is more colorful to satisfy requirements of different users.

Preferably, the light guide material layer has various colors, which may be combined with the strip light, so that the overall light-emitting seat is more colorful to satisfy requirements of different users.

The beneficial effect of the disclosure is that the strip light is cladded through the light guide material layer for light to be refracted in the light guide material layer, so that the light-emitting seat has soft lighting and visual comfort.

### BRIEF DESCRIPTION OF THE DRAWINGS

FIG. 1 is a light-emitting seat according to an embodiment of the disclosure.

FIG. 2 is a light-emitting seat according to another embodiment of the disclosure.

FIG. 3 is a comparison diagram of light rays from a strip light and light rays from a strip light covered with a light guide material layer.

### DETAILED DESCRIPTION OF DISCLOSED EMBODIMENTS

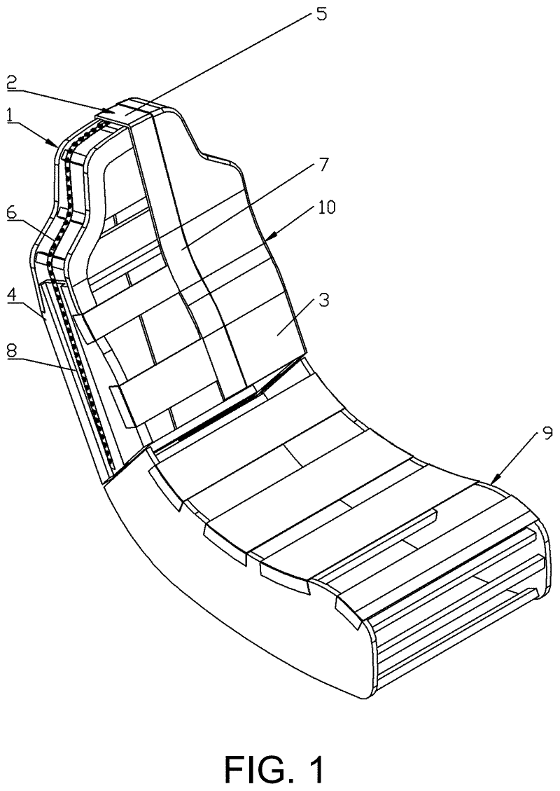

The following describes a light-emitting seat according to an embodiment of the disclosure with reference to FIG. 1, which includes a seat body 1, a strip light module 2, a skin layer 3, and a power supply assembly. The seat body 1 includes a chair frame 4, bandages, and a soft filling layer 7. The bandages are disposed on the chair frame 4. The soft filling layer 7 is disposed outside the chair frame 4 and the bandage. The strip light module 2 includes a strip light 6 and a light guide material layer 5. The strip light 6 is fixed on the chair frame 4. The light guide material layer 5 covers the strip light 6. The light guide material layer 5 and the soft filling layer 7 are integrally formed. A material for integral formation has both functions of light guiding and soft cladding. The skin layer 3 covers the seat body 1 and the strip light module 2, and an area of the skin layer 3 covering the strip light module is a light-transmitting material. The power supply assembly is electrically connected to the strip light 6 to supply electrical energy. The power supply assembly may be a power cord connected to a power source or an assembly that may independently provide electrical energy. Since the assembly is usually used in movable furniture, the power supply assembly is usually a lithium battery. Since the strip light 6 is soft and flexible, the strip light 6 may be arbitrarily disposed on the chair frame 4 according to the structure of the chair frame 4. As shown in FIG. 3, the light guide material layer 5 refracts light to form soft light, so that the overall seat is more aesthetically pleasing. When the distance between the strip light 6 and the light guide material layer 5 is greater than 15 mm, soft light effects are more obvious.

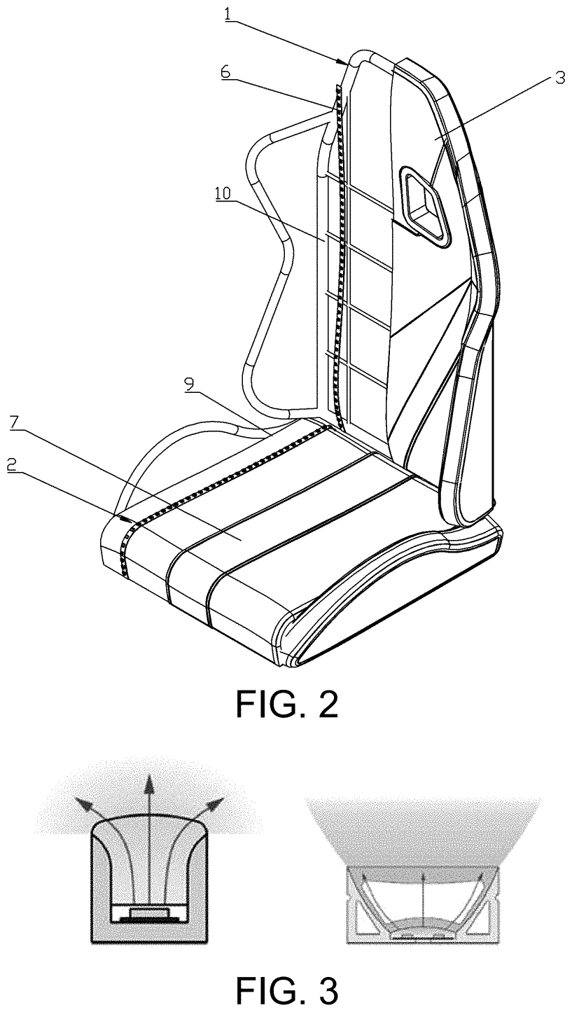

The following describes a light-emitting seat according to an embodiment of the disclosure with reference to FIG. 2, which includes a seat body 1, a strip light module 2, a skin layer 3, and a power supply assembly. The seat body 1 includes a chair frame 4 and a soft filling layer 7. The strip light module 2 includes a strip light 6 and a light guide material layer. The strip light 6 is fixed on the chair frame 4. The soft filling layer 7 is disposed outside the chair frame 4. The light guide material layer covers the strip light 6. The light guide material layer and the soft filling layer 7 are integrally formed. A material for integral formation has both functions of light guiding and soft cladding. The skin layer 3 covers the seat body 1 and the strip light module 2, and an area of the skin layer 3 covering the strip light module is a light-transmitting material. The power supply assembly is electrically connected to the strip light 6 to supply electrical energy. The power supply assembly may be a power cord connected to a power source or an assembly that may independently provide electrical energy. Since the assembly is usually used in movable furniture, the power supply assembly is usually a lithium battery. Since the strip light 6 is soft and flexible, the strip light 6 may be arbitrarily disposed on the chair frame 4 according to the structure of the chair frame 4. As shown in FIG. 3, the light guide material layer refracts light to form soft light, so that the overall seat is more aesthetically pleasing. When the distance between the strip light 6 and the light guide material layer 5 is greater than 15 mm, soft light effects are more obvious.

The disclosure will be further described below in conjunction with the embodiments and the drawings.

There are two manners to fix the strip light 6 on the chair frame 4. As shown in FIG. 2, the first fixing manner is to directly fix a back surface of the strip light 6 on the chair frame 4 in a bonding manner. A bonding body may be a double-sided glue. Such fixing manner is usually used on a metal chair frame. As shown in FIG. 1, the second fixing manner is to fix the strip light 6 in a groove 8 on the surface of the chair frame 4. The groove 8 on the surface of the chair frame 4 may be designed to match the size of the strip light 6, and the strip light 6 is directly engaged with the groove 8. The back surface of the strip light 6 may also be directly fixed in the groove 8 in a bonding manner. Such fixing manner is usually used on a wooden chair frame.

As shown in FIG. 1, the chair frame 4 includes a seat frame 9 and a backrest frame 10. The strip light 6 is disposed on an edge of the seat frame 9 and an edge of the backrest frame 10 to enhance visual effects and satisfy the pursuit of the user for cool effects. The strip light 6 may be disposed in any shape to satisfy requirements of different users.

As shown in FIG. 2, the chair frame 4 includes a seat frame 9 and a backrest frame 10. The strip light 6 may also be disposed in a middle region of the seat frame 9 and a middle region of the backrest frame 10, and the strip light 6 may be arranged in any shape according to the structure of the chair frame to satisfy requirements of different users.

The strip light 6 may emit at least two colors of light, the light guide material layer 7 has various colors, and the two may emit combined color light. The overall strip light module 2 may control a light-emitting color, a light sequence, and whether to emit light of each region, through a control module, to satisfy requirements of different users.

The strip light 6 is an RGB light strip or an LED light strip. The light guide material layer 7 is foam, EVA, or EPE. The light-transmitting material is mesh cloth, silica gel, or transparent plastic.

The above embodiments only express several implementation manners of the disclosure, and the description thereof is relatively specific and detailed. However, the embodiments should not be understood as limitations to the patent scope of the disclosure. It should be pointed out that for persons skilled in the art, several modifications and improvements may be made without departing from the concept of the disclosure, and the modifications and improvements all fall within the protection scope of the disclosure. Therefore, the protection scope of the disclosure should be defined by the appended claims.

1. A light-emitting seat, comprising:
a seat body, including a chair frame and a soft filling layer, wherein the soft filling layer is disposed outside the chair frame;
a strip light module, including a strip light and a light guide material layer, wherein the light guide material layer covers the strip light, and the strip light module is disposed on the chair frame;
a skin layer, cladding the seat body and the strip light module, wherein an area of the skin layer at least covering the strip light module is a light-transmitting material; and
a power supply assembly, electrically connected to the strip light.

2. The light-emitting seat according to claim 1, wherein the soft filling layer and the light guide material layer are integrally formed.

3. The light-emitting seat according to claim 1, wherein the chair frame is provided with a groove for accommodating the strip light, the strip light is fixed in the groove, and the light guide material layer covers the groove.

4. The light-emitting seat according to claim 1, wherein the chair frame comprises a seat frame and a backrest frame.

5. The light-emitting seat according to claim 4, wherein the strip light is disposed on an edge of the backrest frame and/or an edge of the seat frame.

6. The light-emitting seat according to claim 4, wherein the strip light is disposed in a middle region of the backrest frame and/or a middle region of the seat frame.

7. The light-emitting seat according to claim 1, wherein the strip light is selected from one or more of an RGB light strip and an LED light strip.

8. The light-emitting seat according to claim 1, wherein the light guide material layer is selected from one or more of foam, Ethylene Vinyl Acetate (EVA), and expanded polyethylene (EPE).

9. The light-emitting seat according to claim 1, wherein the light-transmitting material is selected from one or more of mesh cloth, silica gel, and transparent plastic.

10. The light-emitting seat according to claim 1, wherein the light-emitting seat further comprises a control panel for receiving a signal to control a color and a sequence of light emitted by the strip light.
